(19) United States
(12) Patent Application Publication
(10) Pub. No.: US 2002/0059467 A1
(43) Pub. Date: May 16, 2002

(54) Object oriented framework architecture for sensing and/or control environments

(75) Inventors: John W. Rapp, Manassas, VA (US); Chandan Mathur, Burke, VA (US); Paul Todd Lane, Warrenton, VA (US)

Correspondence Address: Bryan A. Santarelli, BRAYBEAL JACKSON HALEY LLP, Suite 350, 155-108th Avenue NE, Bellevue, WA, 98004-5901, US

(73) Assignee: Lockheed Martin Corporation

(21) Appl. No.: 09/956,624

(22) Filed: Sep. 19, 2001

Related U.S. Application Data
(60) Provisional application No. 60/233,924, filed on Sep. 20, 2000.

(51) Int. Cl. G06F 15/16

(52) U.S. Cl. 709/250; 709/203

(57) ABSTRACT

An object oriented framework architecture for sensing and/or control environments includes a set of sensing and/or control subsystems; a framework and interface system; a network; and a managing server system. The framework and interface system includes signal exchange modules that communicate with sensing and/or control elements; an expansion bus; and a client computer system. A framework services module within the client computer system retrieves configuration information that characterizes signal exchange modules. The framework services module automatically configures hardware interface modules for communicating with signal exchange modules, and maps signal exchange modules' hardware signals to corresponding events. An event may include an event identifier and a data value. The framework services module exchanges events with application software withinin the managing server system, and exchanges hardware signals with signal exchange modules monitoring or controlling sensing and/or control elements. The framework services module disassociates application software from signal exchange module hardware configuration details.

### RELATED APPLICATIONS

This application claims priority to U.S. Provisional Application Ser. No. 60/233,924, entitled “Object Oriented Framework for Software Drivers,” filed on Sep. 20, 2000.

### STATEMENT REGARDING GOVERNMENT AGENCY CONTRACT

The present invention was first conceived, reduced to practice, and/or built and tested in the course of work under U.S. Government Contract Number N00019-98-C-0012, “MKIII Weapons Systems Trainer.” The U.S. Government has certain rights in the invention.

### BACKGROUND OF THE INVENTION

1. Field of the Invention

The present invention relates generally to communication processes within and/or between sensing and/or control systems. More particularly, the present invention is an object oriented framework architecture through which application software may communicate with local and/or remote sensing and/or control subsystems in a manner that readily accommodates technological evolution and scalability.

2. Description of the Background Art

Sensing and/or control systems may be employed in a wide range of environments, such as simulation, manufacturing automation, industrial control, process monitoring, and/or remote sensing situations. Such systems typically incorporate specialized hardware elements in accordance with a set of requirements associated with a particular environment. The specificity of any given sensing and/or control system may preclude its applicability outside the environment for which it was designed. For example, a flight simulation system or elements therein may be of little or no use in an oil refinery process monitoring system.

Typically, a sensing and/or control system relies upon an application software design that is unique with respect to the system's particular hardware design. Once a hardware design for a given sensing and/or control system is finalized, application software design may proceed. Because software elements within a sensing and/or control system are intimately tied or bound to the system's hardware configuration or organization, the extent to which software elements can be leveraged or reused across different sensing and/or control systems is extremely limited. As a result of the foregoing, the time required to develop and implement a sensing and/or control system is undesirably long, and costs associated therewith are undesirably high.

The dependency of a system's application software design upon the system's hardware design generally precludes system modification or upgrade without time consuming and expensive application software modification, recompilation, and debugging. Present sensing and/or control systems therefore fail to flexibly, efficiently, or adequately accommodate technological evolution.

The dependency of application software upon sensing and/or control system hardware configuration also makes system scalability very difficult. Adding one or more local or remote subsystems to a given sensing and/or control system may necessitate extensive application software modification, recompilation, and debugging, which are typically time consuming, expensive procedures.

What is needed is a sensing and/or control architecture that minimizes the time required to design and implement a sensing and/or control system, and which maximizes system extensibility and scalability.

### SUMMARY OF THE INVENTION

In one embodiment, an object oriented framework architecture for sensing and/or control environments comprises a managing server system coupled to a signal database and a computer network; and a framework and interface system coupled to the computer network and a set of sensing and/or control subsystems. Each sensing and/or control subsystem may comprise sensing and/or control elements appropriate for acquiring and/or distributing analog, digital, serial, or other types of signals within a given sensing and/or control environment under the direction of application software executing within the managing server system.

A framework and interface system may comprise a set of electrical interface units and a client computer system that includes a framework services module. Each electrical interface unit may comprise one or more signal exchange modules coupled to an expansion bus. A signal exchange module may comprise circuitry for exchanging signals with particular sensing and/or control subsystem elements. An expansion bus provides communication datapaths between signal exchange modules and the client computer system.

A signal exchange module may receive electrical signals from sensing and/or control subsystem elements, perform signal conditioning, format conversion, and/or local processing thereupon, and store corresponding hardware signals or data signals in one or more registers or storage elements. Similarly, a signal exchange module may receive hardware signals or data signals from the client computer system, perform any required conversion or processing thereupon, and deliver corresponding electrical signals to appropriate sensing and/or control subsystem elements. A given set of signal exchange modules through which communication with a sensing and/or control subsystem occurs represents a hardware configuration associated with the sensing and/or control subsystem.

Within the client computer system, the framework services module manages communication between application software and signal exchange modules in a manner that disassociates application software from hardware configuration details. In particular, communication between the framework services module and application software is based upon events, where an event may comprise an event identifier and a set of associated data values.

In one embodiment, the framework services module comprises a configuration and initialization module; a memory mapping module; an event coding/decoding module; an inter-process communication (IPC) module; and a scheduling module. The configuration and initialization module may retrieve configuration information from the signal database, and automatically generate a hardware interface module for communicating with a signal exchange module to which the framework services module is coupled. The configuration information may describe or define a signal exchange module's location, characteristics, and communication capabilities.

The event coding/decoding module may encode data signals that a hardware interface module receives from its associated signal exchange module into events directed to application software. Similarly, the event coding/decoding module may decode events received from application software into data signals directed to particular signal exchange modules, after which appropriate hardware interface modules deliver such data signals thereto. The IPC module may manage event-based communication between the framework services module and application software.

In accordance with the present invention, an application program may receive an event, and perform one or more operations as appropriate or required. The application program may generate another event in response to a received event, and send this response event to the client computer system. The framework services module may subsequently decode the response event, and direct or issue a data signal to an appropriate signal exchange module. Thus, an application program may perform sensing and/or control operations without explicit knowledge of which signal exchange module is associated with a given event. The framework services module therefore isolates application software from hardware configuration details.

Hardware configuration changes may be reflected or indicated in signal database objects or tables. The framework services module may automatically generate hardware interface modules that facilitate communication with a modified hardware configuration, without requiring corresponding application software modification, debugging, and testing.

### BRIEF DESCRIPTION OF THE DRAWINGS

FIG. 1 is a block diagram of an object oriented framework architecture for sensing and/or control environments organized in accordance with an embodiment of the invention.

FIG. 2 is a block diagram of a framework and interface system according to an embodiment of the invention.

FIG. 3 is a functional block diagram of a framework services module 330 and a manner of interfacing to signal exchange module hardware according to an embodiment of the invention.

FIG. 4 is a set of signal database objects or tables that specify exemplary configuration information for a signal exchange module implemented as an IP module.

### DETAILED DESCRIPTION

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

The present invention comprises an object oriented framework architecture for sensing and/or control systems. The architecture detailed herein facilitates efficient and cost effective design and implementation of sensing and/or control systems that are extensible and scalable. Those skilled in the art will recognize that the present invention is applicable to essentially any type of local and/or remote sensing and/or control environment.

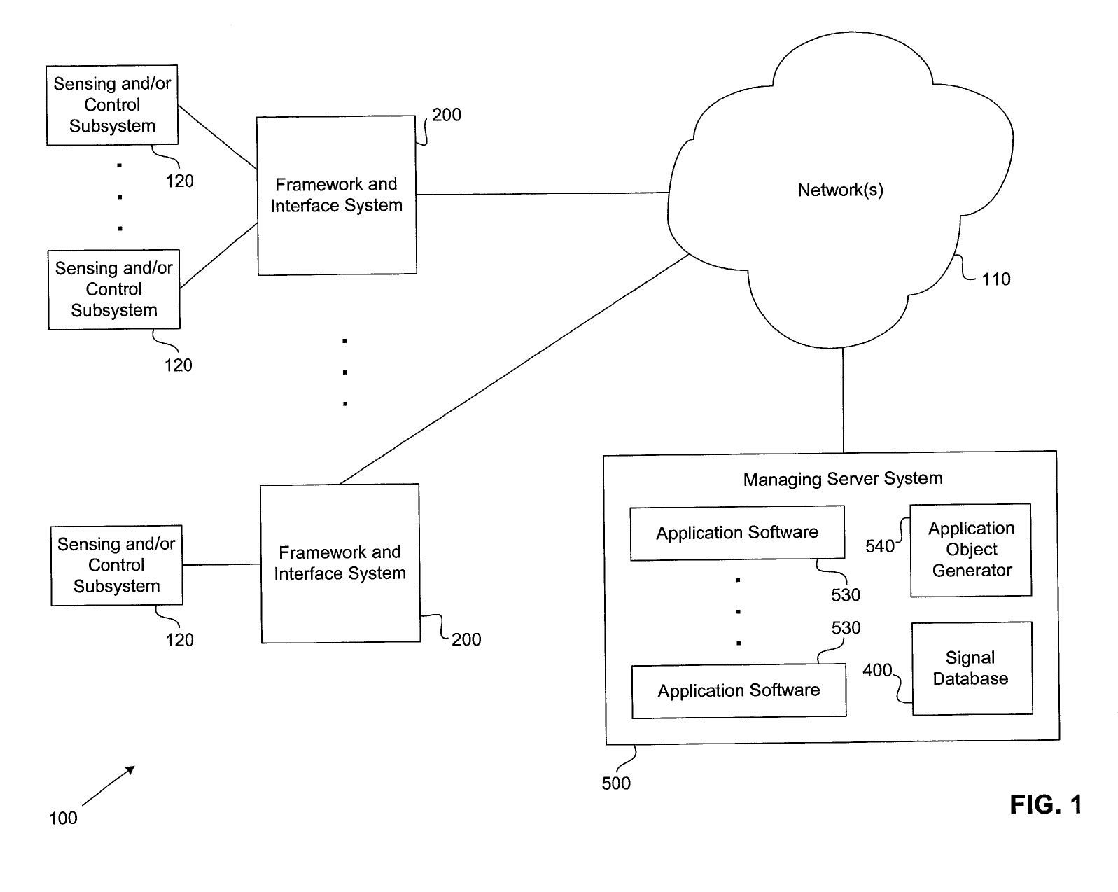

FIG. 1 is a block diagram of an object oriented sensing and/or control framework architecture 100 according to an embodiment of the invention. In one embodiment the object oriented sensing and/or control framework architecture 100 comprises a managing server system 500 in which an application software program 530 (also referred to herein simply as application software) and other software elements 540 may reside; at least one signal database 400 associated with the managing server system 500; at least one framework and interface system 200 having a set of sensing and/or control subsystems 120 associated therewith; and a computer network 110.

The managing server system 500 may be coupled to one or more framework and interface systems 200 via the computer network 110, which may comprise one or more networks of essentially any type, including the Internet, a Wide Area Network (WAN), and/or a Local Area Network (LAN). Those skilled in the art will understand that the computer network 110 may comprise various types of network elements organized to support and/or communicate in accordance with one or more network and/or information transport protocols. In an alternate embodiment, the managing server system 500 may be directly coupled to one or more framework and interface systems 200 in a manner that omits or bypasses the computer network 110.

In one embodiment, any given framework and interface system 200 is coupled to a corresponding sensing and/or control subsystem 120. A sensing and/or control subsystem 120 may comprise various types of sensing and/or control elements directed toward signal acquisition and/or distribution within a particular environment. Such signals may be analog, digital, serial, or of other types, in accordance with the communication formats and/or protocols supported by the sensing and/or control elements to which they correspond. Sensing and/or control subsystem elements may include wire-based, wireless, electro-optic, fiber optic, and/or optical components, in a manner readily understood by those skilled in the art. Sensing elements may include, for example, switches, temperature sensors, pressure sensors, vibration sensors, position or attitude sensors, motion sensors, accelerometers, microphones or hydrophones, and feedback from various types of actuators. Control elements may include lights (e.g., lamps and/or LED's), digital or analog meters, thermostats, hydraulic controls, motor controls, engine controls, transducers, loudspeakers, alarm indicators, stepping motors, and various types of actuators. Examples of signal types that may cross boundaries between the framework and interface system 200 and a sensing and/or control subsystem 120 are shown in Table 1.

TABLE 1
Exemplary Signal Types Supported

| Sensed Signal Type | Controlled Signal Type |
|---|---|
| Synchro (Rotating Power) | Synchro (Rotating Power) |
| Low Voltage Analog | Low Voltage Analog |
| High Voltage Analog | High Voltage Analog |
| Low Current Analog | Low Current Analog |
| High Current Analog | High Current Analog |
| Optically Isolated Interrupt | Optically Isolated Interrupt |
| Low Voltage Discrete Digital | Low Voltage Discrete Digital |
| 5 Volt (TTL Level) Discrete Digital | 5 Volt (TTL Level) Discrete |
| | Digital |
| High Voltage Discrete Digital | High Voltage Discrete Digital |
| IEEE 422, 232 | IEEE 422, 232 |
| ARINC 429, 568, 582 | ARINC 429, 568, 582 |
| MIL 1553B, 1553A | MIL 1553B, 1553A |
| | Relay (Switched Signal or Power) |

In one embodiment, any given sensing and/or control subsystem 120 and/or particular sensing and/or control elements therein may be monitored, managed, and/or controlled by one or more application software programs 530 executing within the managing server system 500. Communication between sensing and/or control subsystems 120 and the managing server system 500 occurs through a framework and interface system 200, as described in detail below.

The managing server system 500 itself may comprise a computer having one or more of the following as required: a processing unit, a set of input devices, a display device, a data storage unit, a network interface unit, and a memory, in a manner readily understood by those skilled in the art. Within the managing server's memory, an operating system may manage access to various hardware and/or software resources in a manner readily understood by those skilled in the art. Those skilled in the art will further understand that the operating system may be a real-time or non-real-time operating system, in accordance with temporal demands associated with any given sensing and/or control environment.

Application software 530 may comprise program instructions that reside within the managing server's memory and/or upon a data storage unit. Typically, a particular application software program 530 is associated with a specific sensing and/or control environment. The network-based access to the managing server system 500 provided by the present invention may facilitate monitoring and/or management of multiple sensing and/or control environments by one or multiple application programs 530. Those skilled in the art will understand that an alternate embodiment may include multiple managing server systems 500, which may facilitate, for example, fail-safe or high-reliability sensing and/or control operations.

In prior sensing and/or control architectures, communication processes between sensing and/or control elements and monitoring and/or control software are inflexibly bound in accordance with a particular hardware configuration. In stark contrast, the present invention provides a self-configuring hardware abstraction layer that generalizes and manages hardware-software communication processes to greatly reduce the extent to which application software 530 is dependent upon hardware configuration details. In one embodiment, a framework and interface system 200, in conjunction with a signal database 400, serves as a configuration and communication interface between one or more sensing and/or control subsystems 120 and application software 530 to provide the aforementioned abstraction layer as described in detail hereafter.

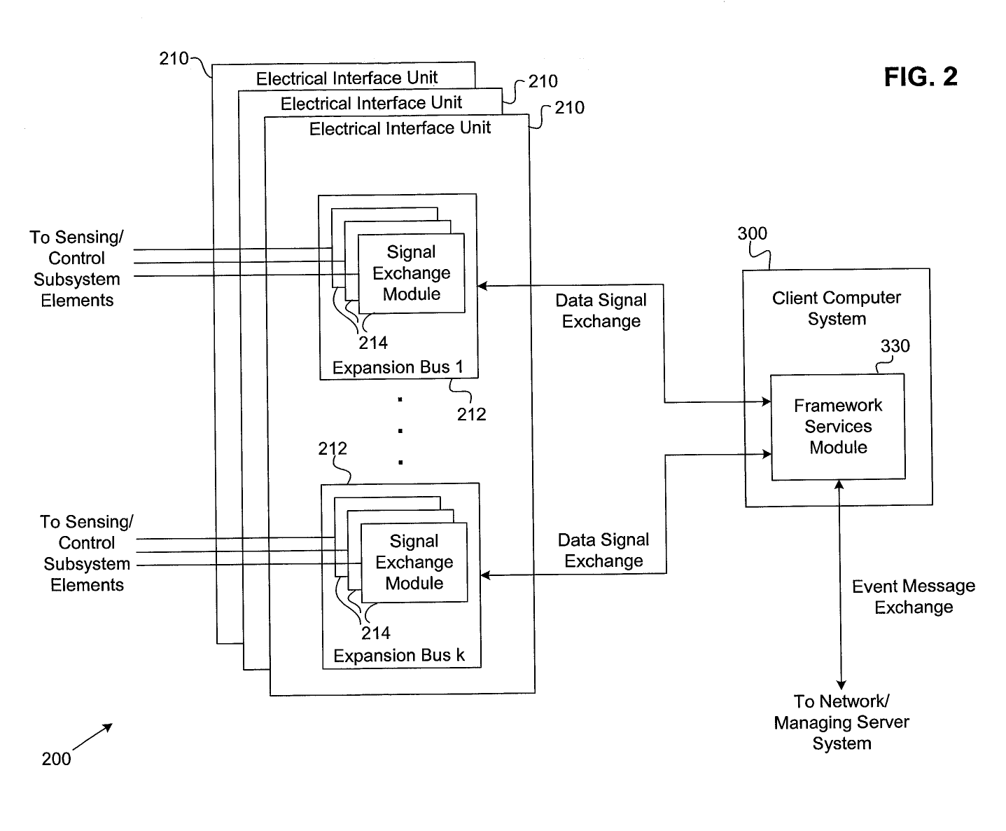

FIG. 2 is a block diagram of a framework and interface system 200 according to an embodiment of the invention. The framework and interface system 200 may comprise a set of electrical interface units 210, and a client computer system 300 having a framework services module 330 therein. Each electrical interface unit 210 may be coupled to a sensing and/or control subsystem 120 as well as the client computer system 300, which may further be coupled to the managing server system 500.

The client computer system 300 may comprise a computer having a processing unit, a set of input devices, a display device, a data storage unit, a network interface unit, and a memory, in a manner readily understood by those skilled in the art. An operating system residing within the memory may manage access to various hardware and/or software resources within the client computer system 300, in a manner readily understood by those skilled in the art. Those skilled in the art will additionally recognize that the operating system may be a real-time or non-real-time operating system in accordance with temporal processing requirements associated with any given sensing and/or control subsystem 120. The framework services module 330 may comprise program instructions that reside within memory and/or upon the data storage unit, and which provide functionality described in detail below.

In one embodiment, an electrical interface unit 210 comprises one or more expansion buses 212 and a set of signal exchange modules 214 coupled thereto. Signal exchange modules 214 may reside upon expansion bus or mezzanine bus cards, which plug into an expansion bus 212 in a conventional manner. Any given expansion bus card upon which a signal exchange module 214 resides may itself reside upon a carrier board. A carrier board may reside within a rack, which may reside within an enclosure, in a manner readily understood by those skilled in the art. Alternatively or additionally, one or more portions of a given electrical interface unit 210 may reside within the client computer system 300.

Any given signal exchange module 214 may correspond to a set of sensing and/or control subsystem elements, and may comprise circuitry for exchanging analog and/or digital signals therewith. A signal exchange module 214 may include analog-to- digital (A/D) and/or digital-to-analog (D/A) conversion circuitry, signal conditioning and/or processing circuitry, interrupt management circuitry, and/or one or more registers or data storage elements, in a manner readily understood by those skilled in the art. A signal exchange module 214 may further include a Programmable Read Only Memory (PROM) that stores information identifying and/or describing the signal exchange module 214 and its supported modes of operation. A signal exchange module 214 may be implemented, for example, using an Industry Pack (IP) module, in a manner readily understood by those skilled in the art.

An expansion bus 212 provides a set of datapaths that facilitate communication between one or more signal exchange modules 214 and the client computer system 300. An expansion bus 212 may comprise essentially any type of bus implemented in accordance with known bus architecture definitions, such as a VersaModular Eurocard (VME) bus or a Peripheral Components Interconnect (PCI) bus.

A signal exchange module 214 may receive an electrical signal from a sensing and/or control subsystem element, perform any required signal conditioning, format conversion, and/or local processing thereupon, and store one or more corresponding hardware signals or data signals in a register, storage element, or memory. An expansion bus 212 to which the signal exchange module 214 is coupled may facilitate transfer of such data signals to or retrieval of such data signals by the client computer system 300. Similarly, the client computer system 300 may transfer one or more data signals to a signal exchange module 214, which may perform any required signal conversion operations thereupon and/or deliver a corresponding electrical signal to a sensing and/or control subsystem element.

Within the client computer system 300, the framework services module 330 manages information exchange between application software 530 and signal exchange modules 214. Communication between the framework services module 330 and signal exchange modules 214 comprises the exchange of hardware signals or data signals. Any given data signal may directly correspond to a particular signal exchange module 214. Moreover, the manner in which any given data signal is exchanged may depend upon the manner in which its associated signal exchange module 214 is implemented.

In contrast, communication between the framework services module 330 and application software 530 comprises the exchange of events. In the context of the present invention, an event corresponds to a condition or occurrence having meaning or relevance to application software 530 for the purpose of monitoring or managing a sensing and/or control subsystem 120. In one embodiment, an event comprises an event identifier and a set of data values associated therewith. As described in detail below, the present invention associates event identifiers with data signals in a flexible manner. The use of event identifiers advantageously disassociates application software 530 from signal exchange module configuration and communication details.

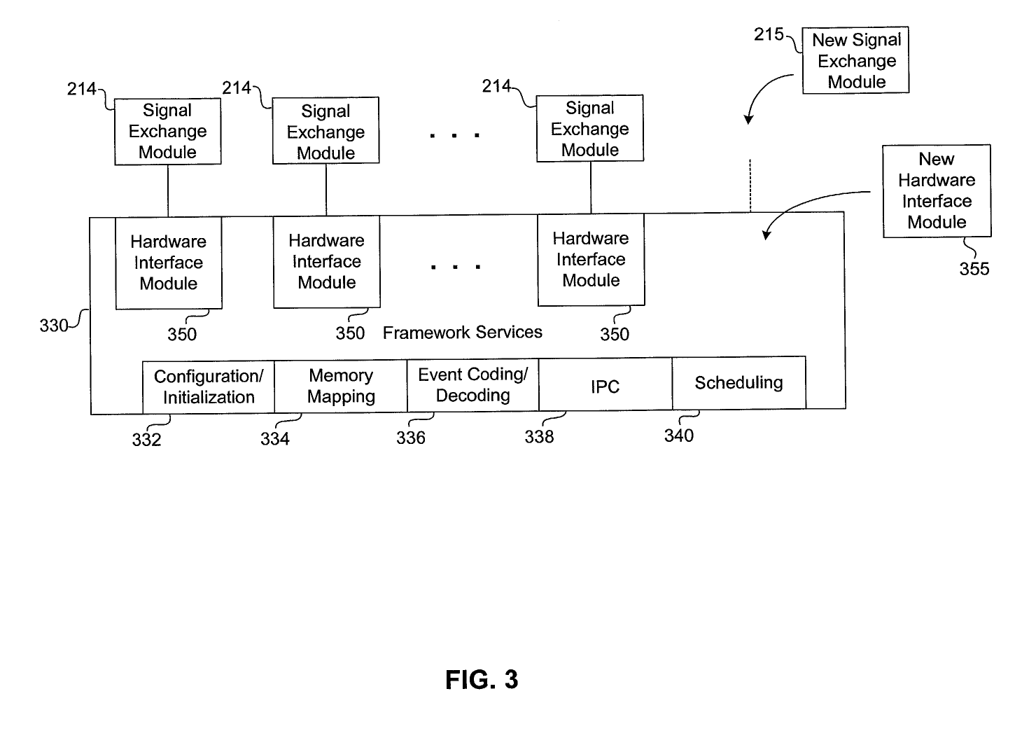

FIG. 3 is a functional block diagram of a framework services module 330 and a manner of interfacing to signal exchange module hardware according to an embodiment of the invention. In one embodiment, the framework services module 330 comprises an object oriented software framework having a configuration and initialization module 332; a memory mapping module 334; an event coding/decoding module 336; an inter-process communication (IPC) module 338; and a scheduling module 338, each of which provides a core type of framework services module functionality as further described below. The framework services module 330 may additionally comprise one or more hardware interface modules 350 that communicate with corresponding signal exchange modules 214. As described in detail below, the configuration and initialization module 332 may automatically generate a hardware interface module 350 in a manner that flexibly accommodates or accounts for hardware dependencies, thereby providing the framework services module 330 with extensible functionality.

The configuration and initialization module 332 may operate during an initialization mode to retrieve from the signal database 400 configuration information describing one or more signal exchange modules 214 within an electrical interface unit 210 to which the framework services module 300 is coupled. The configuration and initialization module 332 may build or generate a hardware interface module 350 for communicating with a signal exchange module 214 using the retrieved configuration information.

In particular, upon retrieving such information associated with a given signal exchange module 214, the configuration and initialization module 332 may initiate or invoke a set of executable files for generating one or more portions of a hardware interface module 350, passing as parameters to such executable files particular configuration information retrieved from the signal database 400. Such parameters may comprise a) one or more location identifiers that uniquely specify where the signal exchange module 214 physically and/or logically resides; b) a communication interface definition for the signal exchange module 214, which may include a port number, one or more interrupt definitions, and/or storage element identifications and/or descriptions; c) data signal definitions for each data signal that the signal exchange module 214 may exchange; d) an event identifier, such as a number and/or character, associated with each such data signal; and/or e) other information, such as a manufacturer name and model number.

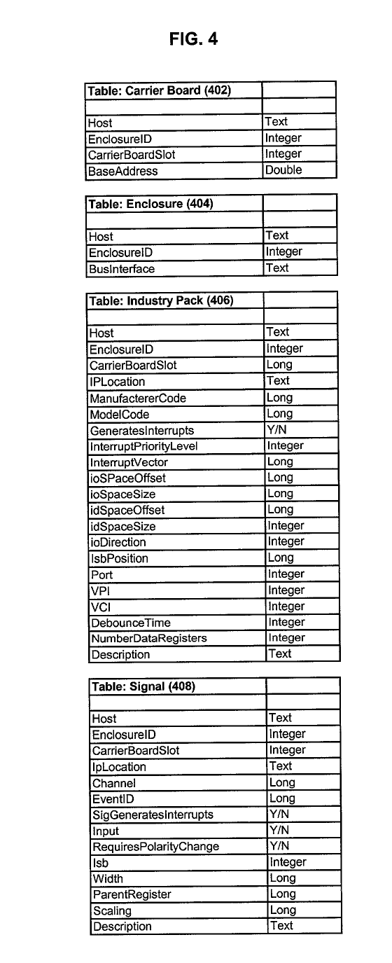

FIG. 4 is a set of signal database objects or tables 402, 404, 406, 408 that specifies exemplary configuration information for a signal exchange module 214 implemented as an IP module. In general, the signal database 400 comprises objects or structures that define a hardware/software boundary. Such objects or structures may include parameters or attributes describing or elaborating upon characteristics of each signal exchange module 214. Such parameters may specify how the signal exchange module 214 may be accessed to exchange particular data signals corresponding thereto, and mappings between such data signals and event identifiers. Particular parameter values within any given signal database object or table 402, 404, 406, 408 may be determined automatically, for example, by retrieval of information specified in one or more hardware description files. In one embodiment, the signal database 400 may reside within a data storage unit associated with the managing server system 500. One or more portions of the signal database 400 may reside elsewhere in an alternate embodiment, such as upon the client computer system 300 or within a Network Attached Storage (NAS) device, in a manner readily understood by those skilled in the art.

Referring again to FIGS. 1-3, the memory mapping module 334 may map a register and/or a memory address space associated with each signal exchange module 214 to addresses within the client computer system's memory, such that signal exchange module storage locations appear as local addresses to the framework services module 330. The event coding/decoding module 336 may encode data signals received from signal exchange modules 214 into corresponding events directed to application software 530 during system operation. The event coding/decoding module 336 may further transform events received from application software 530 into data signals directed to appropriate signal exchange modules 214, after which one or more hardware interface modules 350 may deliver such data signals thereto to effectuate subsystem control. In one embodiment, an event comprises an event identifier and one or more data values representing the data signal that corresponds to the event identifier.

The IPC module 338 may manage communication between the framework services module 330 and application software 530. In one embodiment, the IPC module 338 transmits events to and receives events from application software 530 during system operation. The scheduling module 340 may oversee or perform periodic or aperiodic data collection operations within the framework services module 300 to facilitate communication with application software 530.

Each data signal output by any given signal exchange module 214 may be associated with an event identifier within the signal database 400. Application software 530 is responsive to the receipt of an event rather than direct receipt of a data signal. Upon receipt of an event, the application software 530 may respond by taking an action corresponding to the event, and/or generating another event and returning it to the framework services module 300. The underlying hardware in any given electrical interface unit 210 is thus transparent to the application software 530. In other words, an application program 530 does not require knowledge of which or which type of signal exchange module 214 led to the generation of an event, but need only take appropriate action in response to receipt of such an event. For example, if an operator in a cockpit simulation system moves a switch into an ON position, this may be encoded as event number five. Relative to application software 530, identification of which signal exchange module 214 detected the movement of the switch into the ON position may be unimportant or unnecessary.

The architecture 100 of the present invention thus eliminates the dependency between application software 530 and signal exchange module hardware configuration. The application software 530 need not be modified each time the configuration of signal exchange modules 214 changes, thereby eliminating time consuming application software recompilation, testing, and debugging procedures. For example, a new signal exchange module 215 may be plugged into an electrical interface unit 210 and the signal database 400 may be updated to describe the new signal exchange module 215 in a manner analogous to that detailed above in FIG. 4. In particular, signal database objects 402, 404, 406, 408 corresponding to the new signal exchange module 215 may be created or instantiated as part of a signal database update procedure. The configuration and initialization module 332 may subsequently execute an initialization or update routine, retrieving information from the signal database 400 and generating a new hardware interface module 355 for communicating with the new signal exchange module 215. The architecture 100 of the present invention further provides for hardware debugging and error correction without application software modification in an analogous manner.

The architecture 100 of the present invention may significantly reduce the labor required to provide sensing and/or control system documentation and a translation of a hardware layout into a software design. The signal database 400 includes the needed interface documentation for defining hardware/software boundaries. As engineers analyze external hardware circuitry, the hardware design may be captured in the signal database 400. Software boundary documentation may be provided by a printout of signal database contents.

Typically, software engineers rely upon software boundary documentation to generate code specific to a hardware design. In contrast, the managing server system 500 may include an application object generator 540 that automatically generates objects or code for processing events based upon and/or in accordance with a hardware design captured in the signal database 400. The present invention thereby may significantly reduce the time and cost associated with application software development. Those skilled in the art will understand that an application object generator 540 need not reside and/or execute upon or within the managing server system 500, but may reside and/or execute upon another computer system having access to the signal database 400.

The architecture 100 of present invention may be applied to essentially any type of local or distributed sensing and/or control environment. Additionally, the architecture 100 described herein may be readily scaled. The present invention may include multiple framework and interface systems 200, where signal exchange modules 214 associated therewith are described in a signal database 400. Additionally, because the architecture 100 of the present invention may be network-based and/or internet-based, the present invention may readily facilitate communication between application software 530 and sensing and/or control subsystems 120 located in various parts of the world.

Examples of sensing and/or control environments to which the architecture 100 described herein may be applied include the following: a facility-wide oil refinery control system; a facility-wide electrical power plant control system; a distributed flight simulation training suite having a cockpit simulator in one location for pilots, and a cabin simulator in another location for crew members; an integrated naval ship simulation system, including propulsion, navigation, radar, acoustics, and/or fire control subsystems; an integrated merchant ship simulation system, including propulsion, navigation, radar, and/or cargo hold control and sensing subsystems; and a coastal defense system that includes multiple underwater hydrophone subsystems.

What is claimed is:

1. A system comprising:
a hardware subsystem that includes at least one component adapted to carry an electrical signal associated with one from the group of a sensing operation and a control operation;
a computer network;
a software component coupled to the computer network and providing an application process corresponding to the hardware subsystem; and
a translation interface coupled to the hardware subsystem and the computer network, the translation interface communicating with the hardware subsystem in accordance with the electrical signal, and communicating with the software component in accordance with an event code that corresponds to the electrical signal.

2. The system of claim 1, wherein the computer network comprises one from the group of a Local Area Network, a Wide Area Network, and the Internet.

3. The system of claim 1, wherein the translation interface comprises a computer system.

4. The system of claim 1, further comprising a first computer system in which the software component resides, wherein the translation interface comprises a second computer system.

5. The system of claim 1, wherein the translation interface comprises:
a signal exchange module coupled to the hardware subsystem; and
a computer system coupled to the signal exchange module and the computer network.

6. The system of claim 1 wherein the translation interface comprises:
a signal exchange module coupled to the hardware subsystem; and
a computer system coupled to the signal exchange module and the computer network,
wherein the signal exchange module comprises a card adapted to plug into a standard bus interface.

7. The system of claim 1, wherein the translation interface comprises:
a signal exchange module coupled to the hardware subsystem; and
a computer system coupled to the signal exchange module and the computer network,
wherein the signal exchange module comprises a mezzanine bus card.

8. The system of claim 1, wherein the translation interface comprises:
a signal exchange module coupled to the hardware subsystem; and
a computer system coupled to the signal exchange module and the computer network,
wherein the signal exchange module comprises an Industry Pack module.

9. The system of claim 1, wherein the translation interface comprises:
a signal exchange module coupled to the hardware subsystem;
a computer system coupled to the computer network; and
an expansion bus coupled to the signal exchange module and the computer system.

10. The system of claim 5, further comprising:
a signal database coupled to the computer network, the signal database storing configuration information corresponding to the signal exchange module.

11. The system of claim 5, further comprising:
a signal database coupled to the computer network, the signal database storing configuration information corresponding to the signal exchange module and the event code.

12. The system of claim 1, further comprising a signal database coupled to the computer network, the signal database storing information that facilitates communication between the translation interface and the hardware subsystem.

13. The system of claim 1, further comprising a signal database coupled to the computer network, the signal database storing information that facilitates communication between the translation interface and the hardware subsystem and storing the event code.

14. The system of claim 1, wherein the translation interface comprises a signal exchange module coupled to the hardware subsystem, the signal exchange module including a storage element for storing a hardware signal corresponding to the electrical signal.

15. The system of claim 14, further comprising:
a signal database coupled to the computer network, the signal database storing configuration information corresponding to the signal exchange module, and
wherein the translation interface further comprises a configuration module coupled to retrieve configuration information from the signal database and generate an interface module that facilitates communication between the signal exchange module and the hardware subsystem.

16. The system of claim 14, further comprising:
a signal database coupled to the computer network, the signal database storing configuration information corresponding to the signal exchange module, and
wherein the translation interface further comprises:
a configuration module coupled to retrieve configuration information from the signal database and generate an interface module that facilitates communication between the signal exchange module and the hardware subsystem; and
an event coding-decoding module coupled to map between the electrical signal and the event code.

17. The system of claim 14, further comprising:
a signal database coupled to the computer network, the signal database storing configuration information corresponding to the signal exchange module, and
wherein the translation interface further comprises:
a configuration module coupled to retrieve configuration information from the signal database and generate an interface module that facilitates communication between the signal exchange module and the hardware subsystem;
an event coding-decoding module coupled to map between the electrical signal and the event code; and
an interprocess communication module coupled to manage event-based communication with the software component.

18. The system of claim 14, further comprising:
a signal database coupled to the computer network, the signal database storing configuration information corresponding to the signal exchange module,
wherein the translation interface further comprises:
a local memory;
a configuration module coupled to retrieve configuration information from the signal database and generate an interface module that facilitates communication between the signal exchange module and the hardware subsystem;
an event coding-decoding module coupled to map between the electrical signal and the event code;
an interprocess communication module coupled to manage event-based communication with the software component; and
a memory mapping module that associates the storage element with an address in the local memory.

19. The system of claim 14, further comprising a signal database coupled to the computer network, the signal database including configuration information corresponding to the hardware subsystem.

20. The system of claim 14, further comprising a signal database coupled to the computer network, the signal database including configuration information corresponding to the hardware subsystem and an event code definition associating the event code with the electrical signal.

21. A system comprising:
a plurality of hardware subsystems, each hardware subsystem including at least one component adapted to carry an electrical signal associated with one from the group of a sensing operation and a control operation;
a computer network;
a set of software components coupled to the computer network, the set of software components providing an application process corresponding to the plurality of hardware subsystems; and
a set of translation interfaces, each translation interface coupled to at least one hardware subsystem and the computer network, each translation interface communicating with each hardware subsystem coupled thereto in accordance with an electrical signal associated with the hardware subsystem, each translation interface communicating with the set of software components in accordance with a plurality of event codes, each event code corresponding to an electrical signal associated with a hardware subsystem.

22. The system of claim 21, wherein the computer network comprises one form the group of a Local Area Network, a Wide Area Network, and the Internet.

23. The system of claim 21, further comprising a computer system in which the set of software components resides.

24. The system of claim 21, further comprising a first computer system in which the set of software components resides,
wherein a translation interface comprises a second computer system.

25. The system of claim 21, further comprising a signal database coupled to the computer network, the signal database storing information that facilitates communication between each translation interface and the hardware subsystems coupled thereto.

26. The system of claim 21, further comprising a signal database coupled to the computer network, the signal database storing information that facilitates communication between each translation interface and the hardware subsystems coupled thereto, and storing a plurality of event code definitions.

27. A method of configuring a system, the system including an application software program, a signal database, a translation interface, and a hardware subsystem adapted to carry a set of electrical signals, each electrical signal corresponding to one from the group of a sensing signal and a control signal, the method comprising the steps of:
generating a set of signal database entries defining a translation interface hardware configuration capable of communicating with the hardware subsystem;
retrieving translation interface hardware configuration information from the signal database; and
generating a software interface using the retrieved hardware configuration information, the software interface facilitating communication between the translation interface and the hardware subsystem in accordance with the electrical signal.

28. The method of claim 27, wherein translation interface comprises a set of signal exchange elements, and wherein the hardware configuration represents a signal exchange element configuration within the translation interface, each signal exchange element coupled to the hardware subsystem.

29. The method of claim 27, wherein the step of generating the set of signal database entries further comprises the generation of a set of event code definitions, each event code definition specifying an event code corresponding to an electrical signal.

30. The method of claim 27, further comprising the step of communicating with the hardware subsystem in accordance with the electrical signal and communicating with the application software program in accordance with an event code corresponding to the translation interface hardware configuration.

31. In a system comprising an application software program, a computer network, a translation interface, and a hardware subsystem adapted to carry an electrical signal corresponding to one from the group of a sensing signal and a control signal, a method of performing one from the group of a sensing operation and a control operation comprising the steps of:
receiving the electrical signal at the translation interface;
determining an event code corresponding to the electrical signal; and
communicating the event code over the computer network to the application software program.

32. The method of claim 31, wherein the computer network comprises one from the group of a Local Area Network, a Wide Area Network, and the Internet.

33. The method of claim 31, further comprising the steps of:
determining an event value corresponding to a value of the electrical signal; and
communicating the event value over the computer network to the application software program.

34. In a system comprising an application software program, a computer network, a translation interface, and a hardware subsystem adapted to carry a plurality of electrical signals, each electrical signal corresponding to one from the group of a sensing signal and a control signal, a method of performing one from the group of a sensing operation and a control operation comprising the steps of:
receiving at the translation interface an event code from the application program over a computer network;
determining an electrical signal to which the event code corresponds; and
communicating the determined electrical signal to the hardware subsystem.

35. The method of claim 34, wherein the computer network comprises one from the group of a Local Area Network, a Wide Area Network, and the Internet.

36. The method of claim 34, further comprising the steps of:
receiving at the translation interface an event value associated with the event code; and
determining an electrical signal value based upon the event value.
